(19) United States
(12) Patent Application Publication
(10) Pub. No.: US 2025/0221505 A1
(43) Pub. Date: Jul. 10, 2025

(54) WEARING MEMBER AND WEARABLE ELECTRONIC DEVICE COMPRISING SAME

(71) Applicant: Samsung Electronics Co., Ltd., Suwon-si (KR)

(72) Inventors: Juan LEE, Suwon-si (KR); Insik CHUNG, Suwon-si (KR)

(21) Appl. No.: 19/091,325

(22) Filed: Mar. 26, 2025

Related U.S. Application Data
(63) Continuation of application No. PCT/KR2023/012921, filed on Aug. 30, 2023.

(30) Foreign Application Priority Data
Oct. 6, 2022 (KR) 10-2022-0127853
Nov. 10, 2022 (KR) 10-2022-0149766

(51) Int. Cl. A44C 5/14

(52) U.S. Cl. CPC A44C 5/147

(57) ABSTRACT

A wearing member and a wearable electronic device comprising same are provided. The wearing member includes a strap, a cover assembly coupled to one end of the strap, and a link assembly for fixing the cover assembly to a housing of the wearable electronic device, wherein the link assembly includes a main body containing an internal space a first magnetic member disposed in the internal space, a button member configured to slide in a first direction toward the main body or a second direction away from the main body, and including a first recess, a second magnetic member disposed in the first recess, and facing the first magnetic member, and a fixing member disposed in the internal space, wherein at least a portion of the fixing member is detachably coupled to the housing of the wearable electronic device based on a sliding movement of the button member.

### CROSS-REFERENCE TO RELATED APPLICATION(S)

This application is a continuation application, claiming priority under 35 U.S.C. § 365 (c), of an International application No. PCT/KR2023/012921, filed on Aug. 30, 2023, which is based on and claims the benefit of a Korean patent application number 10-2022-0127853, filed on Oct. 6, 2022, in the Korean Intellectual Property Office, and of a Korean patent application number 10-2022-0149766, filed on Nov. 10, 2022, in the Korean Intellectual Property Office, the disclosure of each of which is incorporated by reference herein in its entirety.

### BACKGROUND

### 1. Field

The disclosure relates to a wearing member and a wearable electronic device including the same.

### 2. Description of Related Art

Wearable electronic device may typically mean a device performing a designated function according to its equipped program, such as a home appliance, an electronic scheduler, a portable multimedia player, a mobile communication terminal, a tablet personal computer (PC), a video/sound device, a desktop PC or laptop computer, a navigation for automobile, etc. As wearable electronic devices are highly integrated, and high-speed, high-volume wireless communication becomes commonplace, a small wearable electronic device, such as a mobile communication terminal, may be equipped with various functions. For example, a wearable electronic device comes with the integrated functionality, including an entertainment function, such as playing video games, a multimedia function, such as replaying music/videos, a communication and security function for mobile banking, and a scheduling and e-wallet function.

Recently, wearable electronic devices that may be worn on the human body are commercially available, and mobile communication terminals and wearable electronic devices are being routinely utilized. A wearable electronic device may remain in contact with the user's body for a long time and may thus be useful for medical or healthcare purposes. In general, a wearable electronic device has a bar shape, a box shape, or a flat plate shape, but a wearable electronic device may be composed of multiple segments considering wearing convenience and the user's body curves. For example, a wrist-worn wearable electronic device may include a housing that serves as a main body and at least one wearable member that receives various circuit devices.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearing member and a wearable electronic device including the same.

Additional aspects will be set forth in part in the description which follows and, in part, will be apparent from the description, or may be learned by practice of the presented embodiments.

In accordance with an aspect of the of the disclosure, a wearing member of a wearable electronic device is provided. The wearing member includes a strap, a cover assembly coupled to one end of the strap, and a link assembly for fixing the cover assembly to a housing of the wearable electronic device. The link assembly includes a main body including an internal space, a first magnetic member disposed in the internal space, a button member configured to slide in a first direction toward the main body or a second direction away from the main body, and including a first recess, a second magnetic member disposed in the first recess and facing the first magnetic member, and a fixing member disposed in the internal space, wherein at least a portion of the fixing member is configured to be detachably coupled to the housing of the wearable electronic device based on a sliding movement of the button member.

In accordance with another aspect of the of the disclosure, a wearable electronic device is provided. The wearable electronic device includes a housing, in which a seating area and a first connection portion are formed, and a wearing member detachably coupled to the seating area. The wearing member includes a strap, a cover assembly coupled to one end of the strap, and a link assembly for fixing the cover assembly to the seating area. The link assembly includes a main body including an internal space, a first magnetic member disposed in the internal space, a button member configured to slide in a first direction toward the main body or a second direction away from the main body, and including a first recess, a second magnetic member disposed in the first recess and facing the first magnetic member, and a fixing member disposed in the internal space, wherein at least a portion of the fixing member is detachably coupled to the first connection portion based on a sliding movement of the button member.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a front perspective view illustrating a wearable electronic device according to an embodiment of the disclosure;

FIG. 2 is a rear perspective view illustrating a wearable electronic device according to an embodiment of the disclosure;

FIG. 3 is an exploded perspective view illustrating a wearable electronic device according to an embodiment of the disclosure;

FIG. 4A is a perspective view illustrating a state in which a housing and a wearing member of a wearable electronic device are separated according to an embodiment of the disclosure;

FIG. 4B is a perspective view illustrating a state in which a housing and a wearing member of a wearable electronic device are separated according to an embodiment of the disclosure;

FIG. 4C is a perspective view illustrating a state in which a housing and a wearing member of a wearable electronic device are coupled according to an embodiment of the disclosure;

FIG. 5A is a perspective view illustrating a first state of a wearing member according to an embodiment of the disclosure;

FIG. 5B is a perspective view illustrating a second state of a wearing member according to an embodiment of the disclosure;

FIG. 5C is a perspective view illustrating a state in which a cover assembly and a link assembly of a wearing member are separated according to an embodiment of the disclosure;

FIG. 6A is an exploded perspective view illustrating a link assembly according to an embodiment of the disclosure;

FIG. 6B is a coupled perspective view illustrating a link assembly according to an embodiment of the disclosure;

FIG. 6C is a coupled perspective view illustrating a link assembly according to an embodiment of the disclosure;

FIG. 7A is a view illustrating a first state of a link assembly according to an embodiment of the disclosure;

FIG. 7B is a view illustrating a second state of a link assembly according to an embodiment of the disclosure;

FIG. 8A is a coupled perspective view illustrating a cover assembly and a strap of a wearing member according to an embodiment of the disclosure;

FIG. 8B is an exploded perspective view illustrating a cover assembly and a strap of a wearing member according to an embodiment of the disclosure;

FIG. 8C is an exploded perspective view illustrating a cover assembly and a strap of a wearing member according to an embodiment of the disclosure;

FIG. 9A is a perspective view illustrating a wearable electronic device according to an embodiment of the disclosure; and

FIG. 9B is a cross-sectional view taken along line A-A′ of FIG. 9A according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

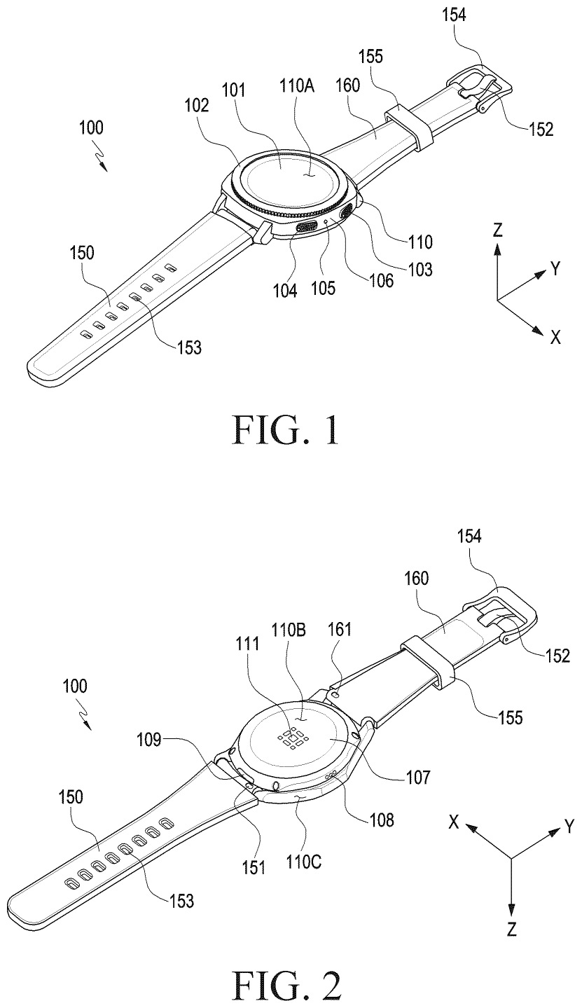

FIG. 1 is a front perspective view illustrating a wearable electronic device according to an embodiment of the disclosure. FIG. 2 is a rear perspective view illustrating a wearable electronic device according to an embodiment of the disclosure.

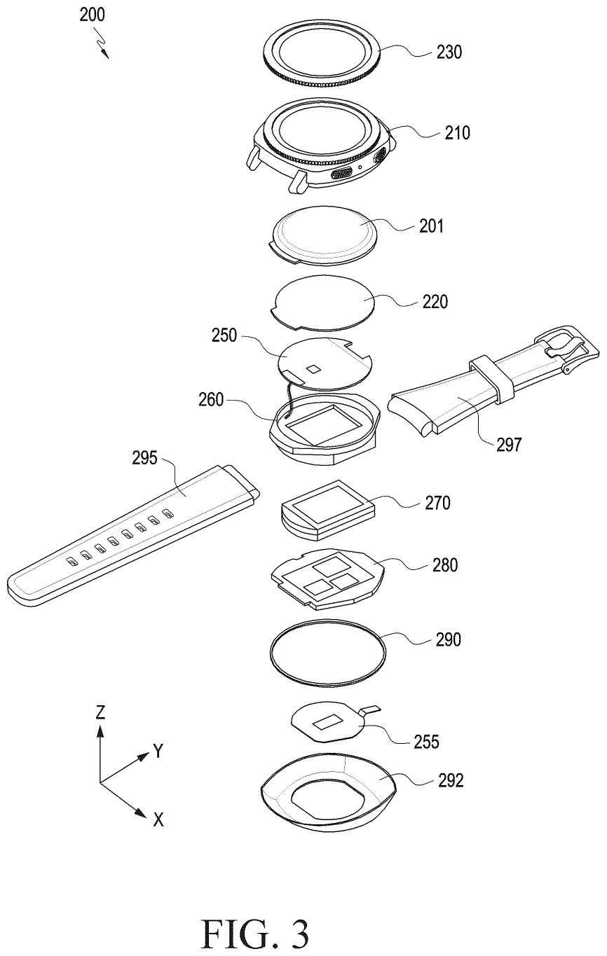

The embodiments of FIGS. 1 and 2 may be combined with the embodiments of FIGS. 3, 4A to 4C, 5A to 5C, 6A to 6C, 7A, 7B, 8A to 8C, 9A, and 9B.

In the following detailed description, in the orthogonal coordinate system of FIGS. 1 to 3, ‘X-axis direction’ may mean the width direction of the wearable electronic device 100 or the housing 110, ‘Y-axis direction’ may mean the length direction of the wearable electronic device 100 or the housing 110, and ‘Z-axis direction’ may mean the thickness direction of the wearable electronic device 100 or the housing 110. Further, the direction in which the front surface (e.g., the first surface 110A of FIG. 1) of the wearable electronic device 100 or the housing 110 faces may be defined as a ‘first direction’ or a ‘+Z direction’, and the direction in which the rear surface (e.g., the second surface 110B of FIG. 2) of the electronic device 100 or the housing 110 faces may be defined as a ‘second direction’ or a ‘−Z direction’.

Referring to FIGS. 1 and 2, according to an embodiment, a wearable electronic device 100 may include a housing 110 including a first surface (or front surface) 110A, a second surface (or rear surface) 110B, and a side surface 110C surrounding the space between the first surface 110A and the second surface 110B and wearing members 150 and 160 connected to at least part of the housing 110 and configured to allow the wearable electronic device 100 to be removably worn on the user's body portion (e.g., the user's wrist or ankle). For example, the wearable electronic device 100 may be of a wrist watch type. According to another embodiment (not shown), the housing may denote a structure forming the first surface 110A of FIG. 1, the second surface 110B of FIG. 2, and some of the side surfaces 110C of FIG. 1. According to an embodiment, at least part of the first surface 110A may have a substantially transparent front plate 101 (e.g., a glass plate or polymer plate including various coat layers). The second surface 110B may be formed of a substantially opaque rear plate 107. According to an embodiment, when the wearable electronic device may include a sensor module 111 disposed on the second surface 110B, the rear plate 107 may at least partially include a transparent area. The rear plate 107 may be formed of, e.g., laminated or colored glass, ceramic, polymer, metal (e.g., aluminum, stainless steel (STS), or magnesium), or a combination of at least two thereof. The side surface 110C may be formed by a side bezel structure (or a “side member”) 106 that couples to the front plate 101 and the rear plate 107 and includes a metal and/or polymer. According to an embodiment, the rear plate 107 and the side bezel plate 106 may be integrally formed together and include the same material (e.g., a metal, such as aluminum). The wearing members 150 and 160 may be formed of various materials in various shapes. A uni-body structure or multiple unit links which is flexible may be formed of fabric, leather, rubber, urethane, metal, ceramic, or a combination of at least two thereof.

According to an embodiment, the wearable electronic device 100 may include at least one or more of a display 220 (refer to FIG. 3), audio modules 105 and 108, a sensor module 111, key input devices 102, 103, and 104, and a connector hole 109. According to an embodiment, the wearable electronic device 100 may exclude at least one (e.g., the key input devices 102, 103, and 104, connector hole 109, or sensor module 111) of the components or may add other components.

The display (e.g., the display 220 of FIG. 3) may be exposed through a significant portion of the front plate 101. The display 220 may have a shape corresponding to the shape of the front plate 101, e.g., a circle, ellipse, or polygon. The display 220 may be coupled with, or disposed adjacent, a touch detection circuit, a pressure sensor capable of measuring the strength (pressure) of touches, and/or fingerprint sensor.

The audio modules 105 and 108 may include a microphone hole 105 and a speaker hole 108. A microphone 105 for obtaining an external sound may be disposed inside the microphone hole. For example, a plurality of microphones may be disposed inside the microphone hole 105 to detect the direction of sound. The speaker hole 108 may be used for an external speaker or a receiver for phone talks. For example, a speaker may be included without the speaker hole (e.g., a piezo speaker).

The sensor module 111 may produce an electrical signal or data value corresponding to the internal operation state or external environment state of the wearable electronic device 100. The sensor module 111 may include, e.g., a biometric sensor module 111 (e.g., a heartrate monitor (HRM) sensor) disposed on the second surface 110B of the housing 110. The wearable electronic device 100 may include a sensor module not shown, e.g., at least one of a gesture sensor, a gyro sensor, a barometric sensor, a magnetic sensor, an acceleration sensor, a grip sensor, a color sensor, an infrared (IR) sensor, a biometric sensor, a temperature sensor, a humidity sensor, or an illuminance sensor.

The key input devices 102, 103, and 104 may include a wheel key 102 disposed on the first surface 110A of the housing 110 to be rotatable in at least one direction and/or key buttons 103 and 104 disposed on the side surface 110C of the housing 110. The wheel key 102 may have a shape corresponding to the shape of the front plate 101. According to an embodiment, the wearable electronic device 100 may exclude all or some of the above-mentioned key input devices 102, 103, and 104 and the excluded key input devices 102, 103, and 104 may be implemented in other forms, e.g., as soft keys on the display 220. The connector hole 109 may receive a connector (e.g., a universal serial bus (USB) connector) for transmitting and receiving power and/or data to/from an external wearable electronic device. Another connector hole (not shown) may be included for receiving a connector for transmitting and receiving audio signals to/from the external wearable electronic device. The wearable electronic device 100 may further include a connector cover (not shown) to cover at least part of, e.g., the connector hole 109 and preventing undesirable materials from entering the connector hole.

The wearing members 150 and 160 may detachably be fastened to at least portions of the housing 110 via locking members 151 and 161. The locking members 151 and 161 may include components or parts for coupling, such as pogo pins, and, according to an embodiment, may be replaced with protrusions or recesses formed on/in the wearing members 150 and 160. For example, the wearing members 150 and 160 may be coupled in such a manner as to be fitted into or over the recesses or protrusions formed on the housing 110. The wearing members 150 and 160 may include one or more of a fastening member 152, fastening member coupling holes 153, a band guide member 154, and a band fastening ring 155.

The fastening member 152 may be configured to allow the housing 110 and the wearing members 150 and 160 to be fastened to the user's body portion (e.g., wrist or ankle). The fastening member coupling holes 153 may fasten the housing 110 and the wearing members 150 and 160 to the user's body portion, corresponding to the fastening member 152. The band guide member 154 may be configured to restrict movement of the fastening member 152 to a certain range when the fastening member 152 fits into one of the fastening member coupling holes 153, thereby allowing the wearing members 150 and 160 to be tightly fastened onto the user's body portion. The band fastening ring 155 may limit the range of movement of the wearing members 150 and 160, with the fastening member 152 fitted into one of the fastening member coupling holes 153.

FIG. 3 is an exploded perspective view illustrating a wearable electronic device according to an embodiment of the disclosure.

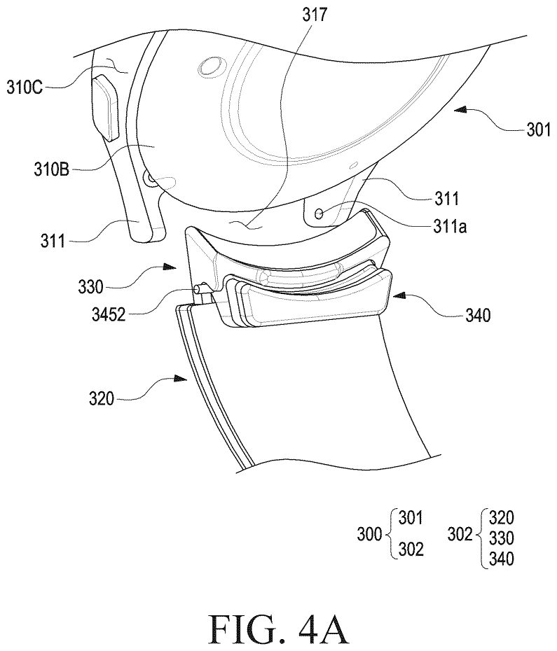

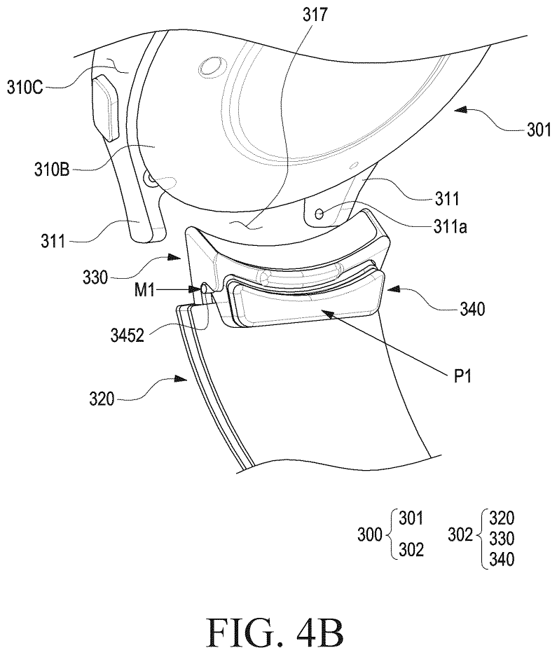

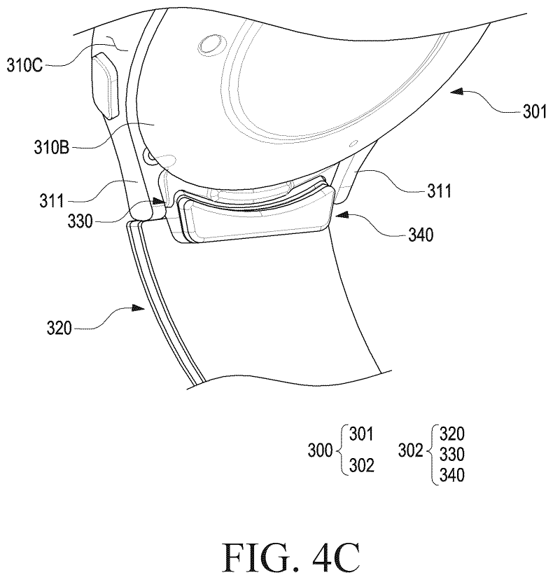

The embodiment of FIG. 3 may be combined with the embodiments of FIGS. 1 and 2 or the embodiments of FIGS. 4A to 4C, 5A to 5C, 6A to 6C, 7A, 7B, 8A to 8C, 9A, and 9B.

Referring to FIG. 3, a wearable electronic device 200 may include a side bezel structure 210, a wheel key 230, a front plate 201 (e.g., the front plate 101 of FIG. 1), a display 220, a first antenna 250, a second antenna (e.g., the antenna included in the second circuit board 255), a supporting member 260 (e.g., a bracket), a battery 270, a printed circuit board 280, a sealing member 290, a rear plate 292, and wearing members 295 and 297. At least one of the components of the wearable electronic device 200 may be the same or similar to at least one of the components of the wearable electronic device 100 of FIG. 1 or 2 and no duplicate description is made below. The supporting member 260 may be disposed inside the wearable electronic device 200 to be connected with the side bezel structure 210 or integrated with the side bezel structure 210. The supporting member 260 may be formed of, e.g., a metal and/or non-metallic material (e.g., polymer). The display 220 may be joined onto one surface of the supporting member 260, and the printed circuit board 280 may be joined onto the opposite surface of the supporting member 274. A processor, memory, and/or interface may be mounted on the printed circuit board 280. The processor may include one or more of, e.g., a central processing unit, an application processor, a graphic processing unit (GPU), a sensor processor, or a communication processor.

The memory may include, e.g., a volatile or non-volatile memory. The interface may include, e.g., a high definition multimedia interface (HDMI), a universal serial bus (USB) interface, a secure digital (SD) card interface, and/or an audio interface. The interface may electrically or physically connect, e.g., the wearable electronic device 200 with an external wearable electronic device and may include a USB connector, an SD card/multimedia card (MMC) connector, or an audio connector.

The battery 270 may be a device for supplying power to at least one component of the wearable electronic device 200. The battery 450 may include, e.g., a primary cell which is not rechargeable, a secondary cell which is rechargeable, or a fuel cell. At least a portion of the battery 270 may be disposed on substantially the same plane as the printed circuit board 280. The battery 270 may be integrally disposed inside the wearable electronic device 200 or may be detachably disposed from the wearable electronic device 200.

The first antenna 250 may be disposed between the display 220 and the supporting member 260. The first antenna 250 may include, e.g., a near-field communication (NFC) antenna, a wireless charging antenna, and/or a magnetic secure transmission (MST) antenna. The first antenna 250 may perform short-range communication with an external device, wirelessly transmit/receive power necessary for charging, or transmit magnetic-based signals including payment data or short-range communication signals. According to an embodiment of the disclosure, an antenna structure may be formed by a portion or combination of the side bezel structure 210 and/or the supporting member 260.

The second circuit board 255 may be disposed between the circuit board 280 and the rear plate 292. The second circuit board 255 may include an antenna, e.g., a near-field communication (NFC) antenna, a wireless charging antenna, and/or a magnetic secure transmission (MST) antenna. For example, the second circuit board 255 may perform short-range communication with an external device, wirelessly transmit/receive power necessary for charging, or transmit magnetic-based signals including payment data or short-range communication signals. According to another embodiment, an antenna structure may be formed of a portion or combination of the side bezel structure 210 and/or the rear plate 292. According to various embodiments, when the wearable electronic device 200 (e.g., the wearable electronic device 100 of FIGS. 1 and 2) includes a sensor module (e.g., the sensor module 111 of FIG. 2), the sensor circuit disposed on the second circuit board 255 or a sensor element (e.g., a photoelectric conversion element or an electrode pad) separate from the second circuit board 255 may be disposed. For example, an electronic component provided as the sensor module 111 may be disposed between the circuit board 280 and the rear plate 292.

The sealing member 290 may be positioned between the side bezel structure 210 and the rear plate 292. The sealing member 290 may be configured to block moisture or foreign bodies that may enter the space surrounded by the side bezel structure 210 and the rear plate 292, from the outside.

FIG. 4A is a perspective view illustrating a state in which a housing and a wearing member of a wearable electronic device are separated according to an embodiment of the disclosure. FIG. 4B is a perspective view illustrating a state in which a housing and a wearing member of a wearable electronic device are separated according to an embodiment of the disclosure. FIG. 4C is a perspective view illustrating a state in which a housing and a wearing member of a wearable electronic device are coupled according to an embodiment of the disclosure.

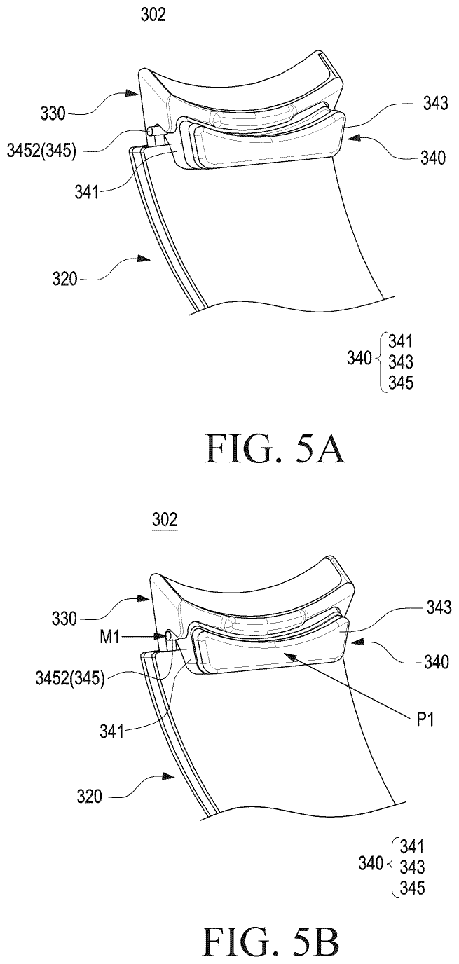

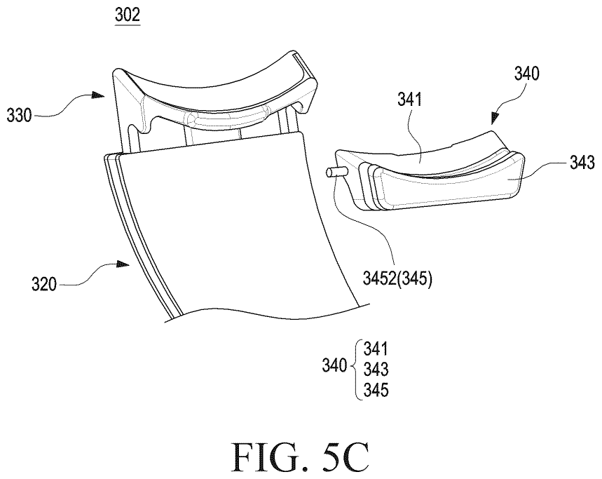

The embodiments of FIGS. 4A to 4C may be combined with the embodiments of FIGS. 1 to 3, or the embodiments of FIGS. 5A to 5C, 6A to 6C, 7A, 7B, 8A to 8C, 9A, and 9B.

Referring to FIGS. 4A to 4C, a wearable electronic device 300 (e.g., the wearable electronic device 100 of FIGS. 1 and 2 or the wearable electronic device 200 of FIG. 3) may include at least one of a housing 301 and a wearing member 302.

The configuration of the housing 301 of FIGS. 4A to 4C may be identical in whole or part to the configuration of the housing 110 of FIGS. 1 and 2, or the configuration of the side bezel structure 210 of FIG. 3. The configuration of the wearing member 302 of FIGS. 4A to 4C may be identical in whole or part to the configuration of the wearing members 150 and 160 of FIGS. 1 and 2, or the wearing members 295 and 297 of FIG. 3.

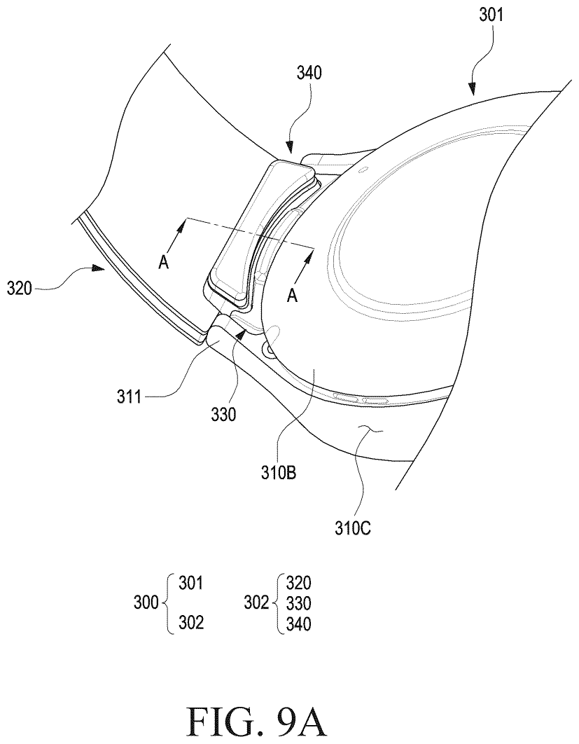

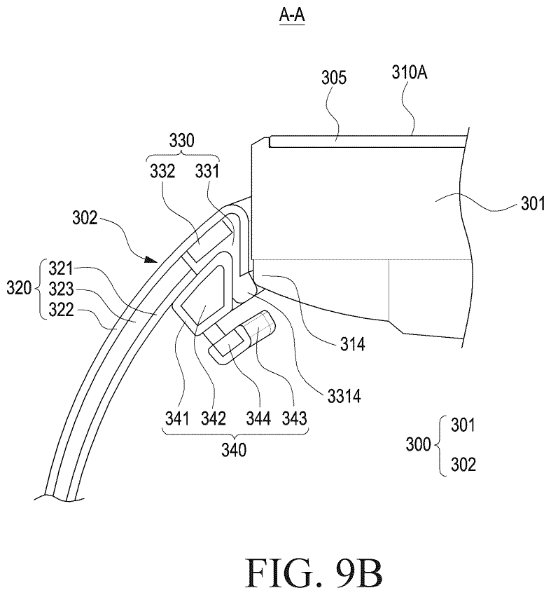

Referring to FIGS. 4A to 4C, the housing 301 may include a front surface (e.g., the front surface 110A of FIGS. 1 and 2 or the front surface 310A of FIG. 9B), a rear surface 310B (e.g., the rear surface 110B of FIGS. 1 and 2), or a side surface 310C (e.g., the side surface 110C of FIGS. 1 and 2). At least a portion of the side surface 310C may be formed by a side bezel structure (e.g., the side bezel structure 106 of FIGS. 1 and 2 or the side bezel structure 210 of FIG. 3).

According to an embodiment, the wearing member 302 may be configured to detachably bind the housing 310 or the wearable electronic device 300 to the user's body (e.g., wrist). For example, a plurality of (e.g., a pair of) wearing members 302 may be provided and respectively disposed at positions symmetrical with respect to the housing 310. For example, as described through the wearable electronic devices 100 and 200 of FIGS. 1 to 3, the user may wear the wearable electronic device 300 on the body by binding a pair of wearing members 302.

According to one embodiment, the housing 301 may include at least one seating area 317 in a portion of the side surface 310C (e.g., the side surface 110C of FIGS. 1 and 2). According to an embodiment, the wearing member 302 may be detachably mounted on the seating area 317. For example, the seating area 317 may be an area formed to be concave in a portion of the side surface 310C of the housing 301. For example, the wearing member 302 may be at least partially received in the seating area 317.

According to an embodiment, the seating area 317 may be referred to as an area surrounded by a plurality of (e.g., a pair of) protruding portions 311 (e.g., lugs) and a side surface 310C of the housing 301 positioned between the pair of protruding portions 311. For example, a pair of protruding portions 311 may be provided on the side surface 310C of the housing 301 to be spaced apart from each other. For example, there may be a plurality of (e.g., a pair of) seating areas 317, and may be disposed to be symmetrical with respect to the housing 301. For example, the protruding portion 311 of the seating area 317 may be integrally formed with the housing 301, or may be formed as a separate member from the housing 301 and coupled to the housing 301. For example, at least one of the pair of protruding portions 311 of the seating area 317, together with the protruding portion 311 positioned closer, of the pair of protruding portions 311 of the other seating area 317 disposed on the opposite side, may be provided as a single member and coupled to the side surface 310C of the housing 301.

According to an embodiment, each of the protruding portions 311 may include a first connection portion 311a. For example, the first connection portion 311a may be a groove formed in at least one portion of one surface where the pair of protruding portions 311 face each other. According to an embodiment, the shape of the first connection portion 311a may be formed to correspond to the shape of the second connection portion 3452 of the wearing member 302. For example, the first connection portion 311a may be configured so that the second connection portion 3452 of the wearing member 302 is inserted thereto. According to an embodiment, the shape and/or position of the seating area 317 and the first connection portion 311a are not limited thereto, and as long as it is a structure to allow the housing 301 and the wearing member 302 to be detachably connected to each other, various changes may be made to the specific shape and/or position.

According to an embodiment, the wearing member 302 may include at least one of a strap 320, a cover assembly 330, and a link assembly 340. The cover assembly 330 may be referred to as a strap cover or a cover member. The link assembly 340 may also be referred to as a strap adapter.

According to an embodiment, the cover assembly 330 may be coupled to one end of the strap 320. According to an embodiment, when the wearing member 302 is coupled to the housing 301, the cover assembly 330 may be disposed in the seating area 317 of the housing 301.

According to an embodiment, the link assembly 340 may be configured to fix the cover assembly 330 coupled to the strap 320 to the housing 301 or to separate the cover assembly 330 fixed to the housing 301 from the housing 301.

According to an embodiment, the link assembly 340 may be bound to the cover assembly 330 through magnetic members to be described below.

According to an embodiment, the link assembly 340 may include a second connection portion 3452. To fix the housing 301 and the cover assembly 330, the second connection portion 3452 may be inserted into the first connection portion 311a of the housing 301. Further, the second connection portion 3452 may be separated from the first connection portion 311a of the housing 301 to separate the housing 301 and the cover assembly 330.

FIG. 4A illustrates a state in which the wearing member 302 is separated from the housing 301, and the wearing member 302 may be in a first state. FIG. 4B illustrates a state in which the wearing member 302 is separated from the housing 301, and the wearing member 302 may be in a second state. FIG. 4C illustrates a state in which the wearing member 302 is coupled to the housing 301, and the wearing member 302 may be in the first state.

For example, the first state may be defined as a state in which the wearing member 302 and the second connection portion 3452 of the link assembly 340 relatively protrude from the main body of the link assembly 340 (e.g., the main body 341 of FIGS. 5A to 5C). For example, the second state may be defined as a state in which the wearing member 302 and the second connection portion 3452 of the link assembly 340 are relatively inserted to the main body (e.g., the main body 341 of FIGS. 5A to 5C) of the link assembly 340, as compared with the first state.

Hereinafter, an operation in which the wearing member 302 is bound to the housing 301 is described with reference to FIGS. 4A to 4C.

In a state in which the housing 301 and the wearing member 302 are separated as shown in FIG. 4A, the user may apply an external input P1 to the link assembly 340 of the wearing member 302 as shown in FIG. 4B. The external input P1 may be defined as the user's action (e.g., pressing or touch) of pressing the button member (e.g., the button member 343 of FIGS. 5A to 5C) of the link assembly 340.

For example, the user may couple or decouple the link assembly 340 to/from the housing 301 by applying an external input to the button member of the link assembly 340. When the external input is applied, at least a portion of the second connection portion 3452 of the link assembly 340 may slide (M1) into the internal space of the main body of the link assembly 340 (e.g., the main body 341 of FIGS. 5A to 5C).

In a state in which the housing 301 and the wearing member 302 are separated as shown in FIG. 4B, the user may release the external input to the button member of the link assembly 340 after inserting the cover assembly 330 of the wearing member 302 into the seating area 317 of the housing 301 as shown in FIG. 4C. When the external input is released, the second connection portion 3452 of the link assembly 340 may be inserted into the first connection portion 311a of the housing 301. Accordingly, the wearing member 302 may be fixed to the housing 301.

According to an embodiment, the direction of the external input P1 may be defined as a direction of pressing or pressurizing the button member, and may be referred to as a first direction.

According to an embodiment, the direction of the slide M1 may be defined as a direction in which the second connection portion 3452 slides and may be referred to as a second direction. The first direction may be defined as a direction different from the second direction or a direction not parallel to the second direction.

FIG. 5A is a perspective view illustrating a first state of a wearing member according to an embodiment of the disclosure. FIG. 5B is a perspective view illustrating a second state of a wearing member according to an embodiment of the disclosure. FIG. 5C is a perspective view illustrating a state in which a cover assembly and a link assembly of a wearing member are separated according to an embodiment of the disclosure.

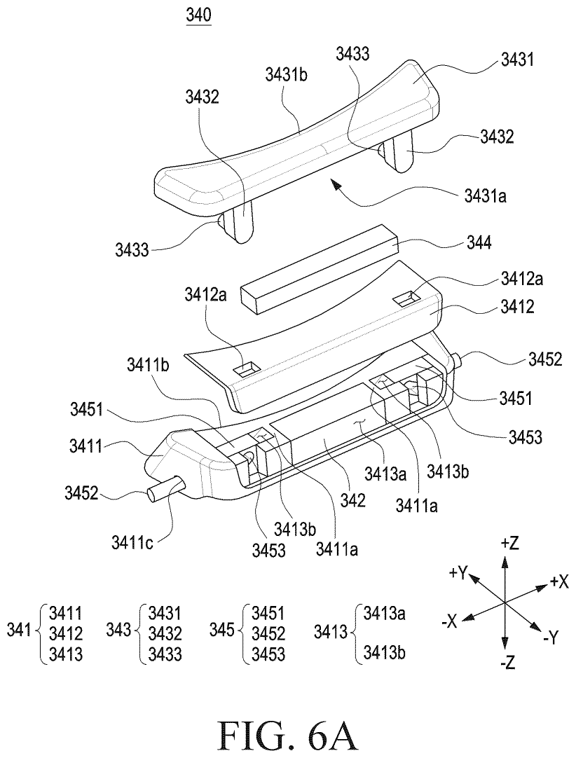

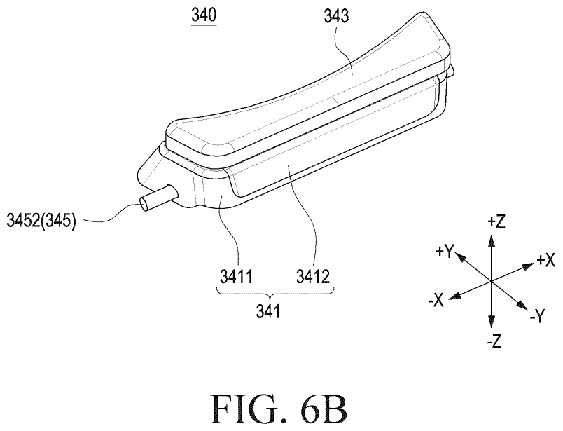

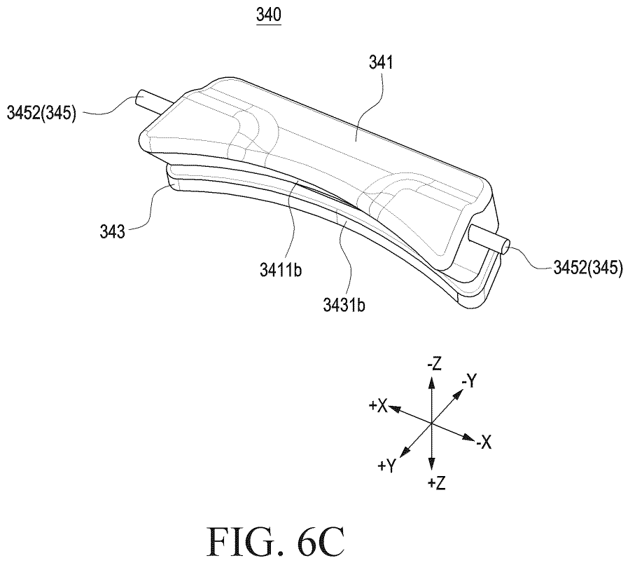

The embodiments of FIGS. 5A to 5C may be combined with the embodiments of FIGS. 1 to 3 and 4A to 4C, or the embodiments of FIGS. 6A to 6C, 7A, 7B, 8A to 8C, 9A, and 9B.

Referring to FIGS. 5A to 5C, the wearing member 302 (e.g., the wearing member 302 of FIGS. 4A to 4C) may include a strap 320, a cover assembly 330, or a link assembly 340.

The configuration of the strap 320, the cover assembly 330, or the link assembly 340 of FIGS. 5A to 5C may be identical in whole or part to the configuration of the strap 320, the cover assembly 330, or the link assembly 340 of FIGS. 4A to 4C.

According to an embodiment, the link assembly 340 may include at least one of a main body 341, a button member 343, or a fixing member 345.

According to an embodiment, the main body 341 of the link assembly 340 may be configured to be inserted into at least a portion of the cover assembly 330. Further, the main body 341 may be configured to be bound to the cover assembly 330 through magnetic members to be described below.

According to an embodiment, the button member 343 may be a component to which an external input is applied. When an external input is applied, the button member 343 may slide in a direction moving toward the main body 341. Furthermore, when the external input is released, the button member 343 may be slid in a direction moving away from the main body 341 through magnetic members described below.

According to an embodiment, the fixing member 345 may include a second connection portion 3452. The second connection portion 3452 may be configured to be inserted into the first connection portion (e.g., the first connection portion 311a of FIGS. 4A to 4C) of the housing (e.g., the housing 301 of FIGS. 4A to 4C).

According to an embodiment, the fixing member 345 may be disposed in the internal space of the main body 341. Further, as the fixing member 345 may be pressed by the button member 343 or the press from the button member 343 is released, the fixing member may slide in the internal space of the main body 341.

Hereinafter, referring to FIGS. 5A and 5B, an operation in which the wearing member 302 is separated from the housing (e.g., the housing 301 of FIGS. 4A to 4C) is described.

Referring to FIGS. 4C and 5A, in a state in which the housing 301 and the wearing member 302 are coupled to each other, as shown in FIGS. 4B and 5B, the user may apply an external input P1 to the button member 343 of the wearing member 302.

For example, by applying an external input P1 to the button member 343 of the link assembly 340, the user may operate the link assembly 340 in a state in which it may be decoupled from the housing 301. When the external input is applied, at least a portion of the second connection portion 3452 of the link assembly 340 may slide (M1) into the internal space of the main body 341 of the link assembly 340.

Further, as shown in FIGS. 4B and 5B, if at least a portion of the second connection portion 3452 of the link assembly 340 slides into the internal space of the main body 341, the second connection portion 3452 of the link assembly 340 may be separated from the first connection portion of the housing (e.g., the first connection portion 311a of FIGS. 4A to 4C). Accordingly, the wearing member 302 may be separated from the housing.

FIG. 5C illustrates a state in which the cover assembly 330 and the link assembly 340 are separated from each other. According to an embodiment, the cover assembly 330 and the link assembly 340 may maintain a mutually bound state through magnetic members to be described below. Further, if the user withdraws the link assembly 340 in a direction moving away from the cover assembly 330, the bound state of the link assembly 340 and the cover assembly 330 may be released.

FIG. 6A is an exploded perspective view illustrating a link assembly according to an embodiment of the disclosure.

FIG. 6B is a coupled perspective view illustrating a link assembly according to an embodiment of the disclosure.

FIG. 6C is a coupled perspective view illustrating a link assembly according to an embodiment of the disclosure.

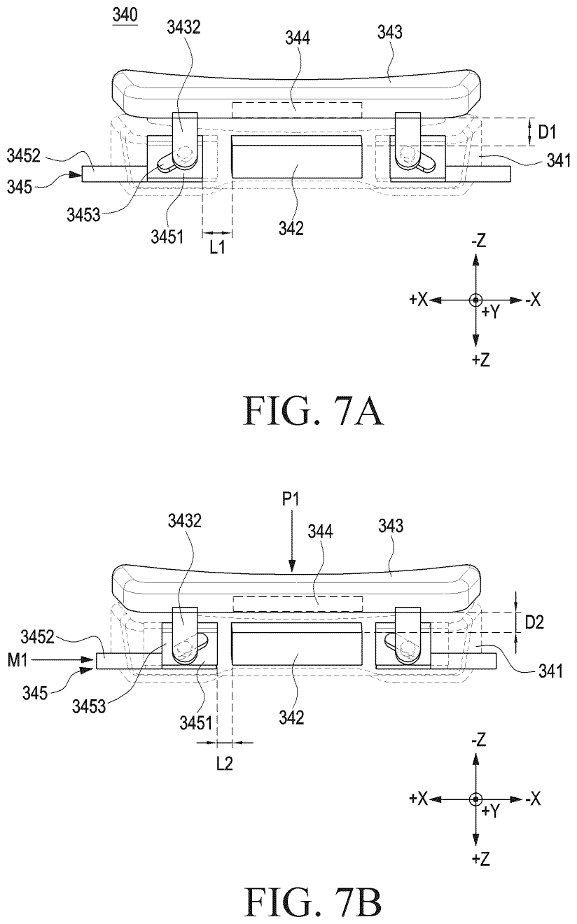

The embodiments of FIGS. 6A to 6C may be combined with the embodiments of FIGS. 1 to 3, 4A to 4C, and 5A to 5C, or the embodiments of FIGS. 7A, 7B, 8A to 8C, 9A, and 9B.

Referring to FIGS. 6A to 6C, the link assembly 340 may include a main body 341, a first magnetic member 342, a button member 343, a second magnetic member 344, or a fixing member 345.

The configuration of the link assembly 340 of FIGS. 6A to 6C may be identical in whole or part to the configuration of the link assembly 340 of FIGS. 5A to 5C.

According to an embodiment, the main body 341 may include a first main body portion 3411, a second main body portion 3412, or an internal space 3413.

According to an embodiment, the first main body portion 3411 may be coupled to the second main body portion 3412. According to an embodiment, the first main body portion 3411 may provide a space for receiving the first magnetic member 342 or the fixing member 345.

According to an embodiment, the internal space 3413 may be a space formed between the first main body portion 3411 and the second main body portion 3412 when the first main body portion 3411 and the second main body portion 3412 are coupled. According to an embodiment, the internal space 3413 is a space formed in the first main body portion 3411, and the second main body portion 3412 may be defined as being coupled to the first main body portion 3411 to cover (or seal) the internal space 3413.

According to an embodiment, the internal space 3413 may include a first internal space 3413a in which the second magnetic member 344 is disposed and a second internal space 3413b in which the fixing member 345 is disposed. The first internal space 3413a and the second internal space 3413b may be partitioned by a partition wall 3411a of the first main body portion 3411.

According to an embodiment, the first main body portion 3411 may include a first curved surface 3411b formed to correspond to a side surface (e.g., the side surface 310C of FIGS. 4A to 4C) of the housing (e.g., the housing 301 of FIGS. 4A to 4C).

According to an embodiment, the first main body portion 3411 may include through holes 3411c formed in two opposite sides of the first main body portion 3411. The second connection portion 3452 of the fixing member 345 may be disposed in the through hole 3411c. The through hole 3411c may be a hole formed through to connect the outside of the first main body portion 3411 and the second internal space 3413b of the first main body portion 3411.

According to an embodiment, the second main body portion 3412 may be coupled to the first main body portion 3411. According to an embodiment, the second main body portion 3412 may be coupled to the first main body portion 3411 to cover the first magnetic member 342 and the pair of fixing members 345 disposed in the internal space 3413.

According to an embodiment, the second main body portion 3412 may include a pair of first openings 3412a where the first protruding portion 3432 of the button member 343 is disposed. The pair of first openings 3412a may be openings formed through the second main body portion 3412 so that the first protruding portion 3432 of the button member 343 may be inserted.

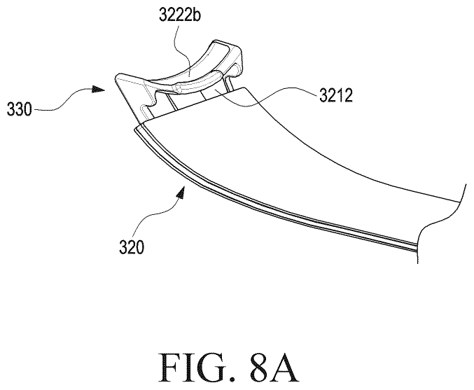

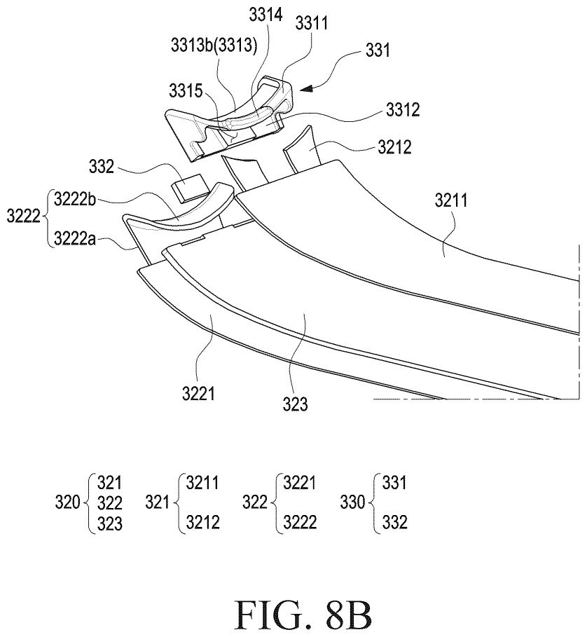

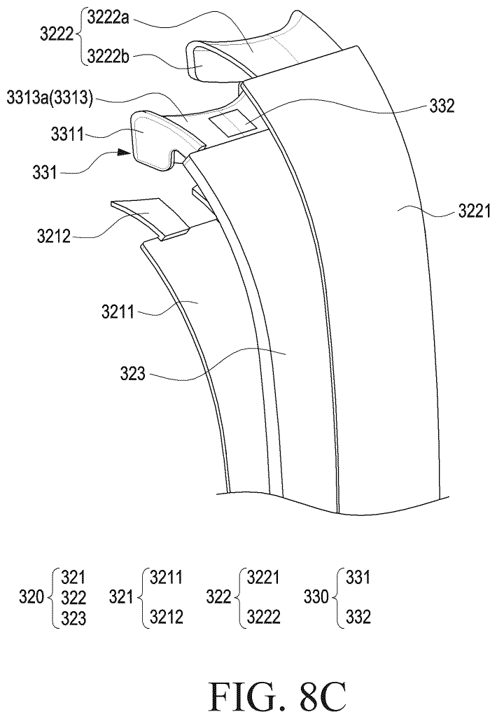

According to an embodiment, the first magnetic member 342 may be disposed in the first internal space 3413a of the main body 341. The first magnetic member 342 may include a permanent magnet. The first magnetic member 342 may be disposed to exert a repulsive force to the second magnetic member 344, and may be disposed to exert an attractive force to a third magnetic member (e.g., the third magnetic member 332 of FIGS. 8A to 8C) to be described below.

According to an embodiment, the button member 343 may include a first body portion 3431, a first protruding portion 3432, or a second protruding portion 3433.

According to an embodiment, the first body portion 3431 may be a portion to which a user input is applied. Further, the first body portion 3431 may include a first recess 3431a recessed in a portion toward the main body 341. The first recess 3431a may be formed in a shape corresponding to the second magnetic member 344.

According to an embodiment, the first body portion 3431 may include a second curved surface 3431b formed to correspond to a side surface (e.g., the side surface 310C of FIGS. 4A to 4C) of the housing (e.g., the housing 301 of FIGS. 4A to 4C).

According to an embodiment, the first protruding portion 3432 may extend to protrude from the first body portion 3431 toward the main body 341. The first protruding portion 3432 may be inserted into the first opening 3412a of the second main body portion 3412. According to an embodiment, at least a portion of the first protruding portion 3432 may be disposed in the second internal space 3413b.

According to an embodiment, the second protruding portion 3433 may extend to protrude from at least a portion of the first protruding portion 3432 toward the fixing member 345. At least a portion of the second protruding portion 3433 may be inserted into the inclined portion 3453 of the fixing member 345.

According to an embodiment, the second magnetic member 344 may be disposed in the first recess 3431a of the button member 343. According to an embodiment, the second magnetic member 344 may include a permanent magnet. The second magnetic member 344 may be disposed to exert a repulsive force to the first magnetic member 342. For example, if the portion of the second magnetic member 344 facing the first magnetic member 342 is the N pole or the S pole, the portion of the first magnetic member 342 facing the second magnetic member 344 may be the N pole or the S pole.

According to an embodiment, the fixing member 345 may include a second body portion 3451, a second connection portion 3452, or an inclined portion 3453.

According to an embodiment, the second body portion 3451 may be disposed in the second internal space 3413b. Further, as the second body portion 3451 may be pressed from the button member 343, or the press from the button member 343 may be released, the second body portion 3451 may slide in the second internal space 3413b. A detailed description of this is described below.

According to an embodiment, the second connection portion 3452 may extend from the second body portion 3451 and may be disposed in the through hole 3411c. At least a portion (or one end) of the second connection portion 3452 may be exposed to the outside of the main body 341. When the second body portion 3451 slides, the second connection portion 3452 may slide together.

According to an embodiment, the inclined portion 3453 may be a groove formed to be recessed or a slit formed through at least a portion of the second body portion 3451. The inclined portion 3453 may extend in a direction inclined with respect to the sliding direction of the button member 343 (e.g., the Z-axis direction of FIG. 6A) and the sliding direction of the second body portion 3451 (e.g., the X-axis direction of FIG. 6A).

FIG. 7A is a view illustrating a first state of a link assembly according to an embodiment of the disclosure. FIG. 7B is a view illustrating a second state of a link assembly according to an embodiment of the disclosure.

The embodiments of FIGS. 7A and 7B may be combined with the embodiments of FIGS. 1 to 3, 4A to 4C, 5A to 5C, and 6A to 6C, or the embodiments of FIGS. 8A to 8C, 9A, and 9B.

Referring to FIGS. 7A and 7B, the link assembly 340 (e.g., the link assembly 340 of FIGS. 6A to 6C) may include the configuration of the main body 341, the first magnetic member 342, the button member 343, the second magnetic member 344, or the fixing member 345.

The configuration of the main body 341, the first magnetic member 342, the button member 343, the second magnetic member 344, or the fixing member 345 of FIGS. 7A and 7B may be identical in whole or part to the configuration of the main body 341, the first magnetic member 342, the button member 343, the second magnetic member 344, or the fixing member 345 of FIGS. 6A to 6C.

Referring to FIG. 7A, a first state of the link assembly 340 (or a wearing member) is illustrated.

According to an embodiment, in the first state, the button member 343 may slide in a direction moving away from the main body 341 (e.g., the −Z axis direction of FIG. 7A) due to the repulsive force formed between the first magnetic member 342 and the second magnetic member 344. Further, in the first state, the first magnetic member 342 and the second magnetic member 344 may be spaced apart by a 1-1th separation distance D1.

In the first state, as the button member 343 slides in a direction moving away from the main body 341, the first protruding portion 3432 of the button member 343 may slide in the moving-away direction (e.g., the −Z axis direction of FIG. 7A).

In the first state, as the first protruding portion 3432 slides in the moving-away direction, the second protruding portion (e.g., the second protruding portion 3433 of FIG. 6A) inserted into the inclined portion 3453 of the fixing member 345 may press at least a portion of the inclined portion 3453. As a result, as the second body portion 3451 slides in a direction moving away from the first magnetic member 342 (e.g., the +X axis direction or −X axis direction of FIG. 7A), the second connection portion 3452 remain relatively a lot exposed to the outside of the main body 341.

Further, in the first state, the first magnetic member 342 and the second body portion 3451 may be spaced apart by a 2-1th separation distance L1.

Referring to FIG. 7B, a second state of the link assembly 340 (or a wearing member) is illustrated.

According to an embodiment, in the second state, the button member 343 may slide in a direction (e.g., the +Z axis direction of FIG. 7B) moving toward the main body 341 due to the external input P1. Further, in the second state, the first magnetic member 342 and the second magnetic member 344 may be spaced apart by the 1-2th separation distance D2. The 1-2th separation distance D2 may be smaller than the 1-1th separation distance D1.

In the second state, as the button member 343 slides in a direction moving toward the main body 341, the first protruding portion 3432 of the button member 343 may slide in the moving toward direction (e.g., the +Z axis direction of FIG. 7B).

In the second state, as the first protruding portion 3432 slides in the moving toward direction, the second protruding portion (e.g., the second protruding portion 3433 of FIG. 6A) inserted into the inclined portion 3453 of the fixing member 345 may press at least a portion of the inclined portion 3453. Accordingly, as the second body portion 3451 slides (M1) in the direction moving toward the first magnetic member 342 (e.g., the −X axis direction or +X axis direction of FIG. 7B), the second connection portion 3452 may remain relatively a lot inserted into the internal space of the main body 341.

Further, in the second state, the first magnetic member 342 and the second body portion 3451 may be spaced apart by a 2-2th separation distance L2. The 2-2th separation distance L2 may be smaller than the 2-1th separation distance L1.

FIG. 8A is a coupled perspective view illustrating a cover assembly and a strap of a wearing member according to an embodiment of the disclosure. FIG. 8B is an exploded perspective view illustrating a cover assembly and a strap of a wearing member according to an embodiment of the disclosure. FIG. 8C is an exploded perspective view illustrating a cover assembly and a strap of a wearing member according to an embodiment of the disclosure.

The embodiments of FIGS. 8A to 8C may be combined with the embodiments of FIGS. 1 to 3, 4A to 4C, 5A to 5C, 6A to 6C, 7A, and 7B, or the embodiments of FIGS. 9A to 9B.

Referring to FIGS. 8A to 8C, the strap 320 may include a plurality of (e.g., three) layers. For example, the strap 320 may include a first portion 321 forming an outer surface of the strap 320 and a second portion 322 forming an inner surface of the strap 320 facing the outer surface. Further, the strap 320 may further include an intermediate member 323 disposed between the first portion 321 and the second portion 322. For example, the intermediate member 323 may be a member forming a thickness between the first portion 321 and the second portion 322. In an embodiment, the intermediate member 323 may be surrounded by the first portion 321 and/or the second portion 322 so as not to be exposed to the exterior of the strap 320 or, according to an embodiment, the intermediate member 323 may be omitted. In an embodiment, the strap 320 may be formed as a single layer. According to one embodiment, the strap 320 is detachably coupled to the cover assembly 330 so that only the strap 320 may be replaced for the cover assembly 330 as needed.

According to an embodiment, the first portion 321 may include a first extension 3211 and a first coupling portion 3212 extending from one end of the first extension 3211.

According to an embodiment, the first extension 3211 may be a portion of the first portion 321 that contacts the user's wrist. According to an embodiment, the first coupling portion 3212 may be coupled to the first seating portion 3312 of the cover assembly 330. In an embodiment, an adhesive member (not shown) may be provided in a portion of the first coupling portion 3212 facing the first seating portion 3312 to bind the first seating portion 3312 and the first coupling portion 3212 to each other.

According to an embodiment, the second portion 322 may include a second extension 3221 and a second coupling portion 3222 extending from one end of the second extension 3221. According to an embodiment, the second extension 3221 may be a portion forming the outer surface of the strap 320 when the wearable electronic device is worn on the user's wrist.

According to an embodiment, the second coupling portion 3222 may be coupled to the second seating portion 3313 of the cover assembly 330. In an embodiment, an adhesive member (not shown) may be provided in a portion of the second coupling portion 3222 facing the second seating portion 3322, to bind the second seating portion 3313 and the second coupling portion 3222 to each other.

According to an embodiment, the second coupling portion 3222 may include a 2-1th coupling portion 3222a extending from one end of the second extension 3221 and a 2-2th coupling portion 3222b bent and extending from extending by the 2-1th coupling portion 3222a.

According to one embodiment, the cover assembly 330 may include a cover member 331 and a third magnetic member 332 disposed on the cover member 331.

According to an embodiment, the cover member 331 may be detachably coupled to the main body (e.g., the main body 341 of FIGS. 7A and 7B) of the link assembly (e.g., the link assembly 340 of FIGS. 7A and 7B). Further, the cover member 331 may be coupled to or separated from the housing of the wearable electronic device (e.g., the housing of FIGS. 4A to 4C) by the main body of the link assembly.

According to an embodiment, the cover member 331 may include a third body portion 3311 forming a body. According to an embodiment, the cover member 331 is a recess formed in at least one portion of the third body portion 3311 and may include a first seating portion 3312 coupled to the first coupling portion 3212.

According to an embodiment, the cover member 331 is a recess formed in at least one portion of the third body portion 3311 and may include a second seating portion 3313 coupled to the second coupling portion 3222.

The second seating portion 3313 may include a 2-1th seating portion 3313a coupled to the 2-1th coupling portion 3222a and a 2-2th seating portion 3313b coupled to the 2-2th coupling portion 3222b. According to an embodiment, when the 2-1th coupling portion 3222a and the 2-2th seating portion 3313b are coupled to each other, the third magnetic member 332 may be covered (or sealed) by the 2-1th coupling portion 3222a.

According to an embodiment, the cover member 331 may further include a second recess 3315 formed in at least a portion of the 2-2th seating portion 3313b. The second recess 3315 may be formed in a shape corresponding to the third magnetic member 332.

According to an embodiment, the cover member 331 may further include a hooked structure 3314 protruding from at least a portion of the third body portion 3311. The hooked structure 3314 may prevent the wearing member from being separated from the housing while the wearing member is bound to the housing.

According to one embodiment, the third magnetic member 332 may be inserted into the second recess 3315 formed in the 2-1th seating portion 3313a. According to an embodiment, the third magnetic member 332 may include a permanent magnet. The third magnetic member 332 may be disposed to exert an attractive force with the first magnetic member (e.g., the first magnetic member 342 of FIGS. 7A and 7B). For example, if the portion of the third magnetic member 332 facing the first magnetic member is the N pole or the S pole, the portion of the first magnetic member facing the third magnetic member may be the S pole or the N pole.

FIG. 9A is a perspective view illustrating a wearable electronic device according to an embodiment of the disclosure.

FIG. 9B is a cross-sectional view taken along line A-A′ of FIG. 9A according to an embodiment of the disclosure.

The embodiments of FIGS. 9A and 9B may be combined with the embodiments of FIGS. 1 to 3, 4A to 4C, 5A to 5C, 6A to 6C, 7A, 7B, and 8A to 8C.

Referring to FIGS. 9A and 9B, the wearable electronic device 300 (e.g., the wearable electronic device 300 of FIGS. 4A to 4C) may include a housing 301 and a wearing member 302.

The configuration of the housing 301 of FIGS. 9A and 9B may be identical in whole or part to the configuration of the housing 301 of FIGS. 4A to 4C. The configuration of the wearing member 302 of FIGS. 9A and 9B may be identical in whole or part to the configuration of the wearing member 302 of FIGS. 4A to 4C, 5A to 5C, 6A to 6C, 7A, 7B, and 8A to 8C. According to an embodiment, the housing 301 may include a front surface 310A, a rear surface 310B, and a side surface 310C. According to an embodiment, the wearable electronic device 300 may further include a display 305 forming the front surface 310A of the housing 301.

According to an embodiment, the wearing member 302 may include a strap 320, a cover assembly 330, and a link assembly 340.

According to an embodiment, the strap 320 may include a first portion 321, a second portion 322, and an intermediate member 323. According to an embodiment, the cover assembly 330 may include a cover member 331 and a third magnetic member 332. According to an embodiment, the link assembly 340 may include a main body 341, a first magnetic member 342, a button member 343, and a second magnetic member 344.

According to an embodiment, the cover member 331 of the cover assembly 330 may include a hooked structure 3314. When the wearing member 302 is coupled to the housing 301, the hooked structure 3314 may come in contact with at least one portion 314 of the housing 301. The hooked structure 3314 may be hooked and fixed to at least one portion 314 of the housing 301 (e.g., a portion or edge of the rear surface 310B of the housing 301). According to an embodiment, the wearing member 302 may be prevented from escaping off while the wearing member 302 is coupled to the housing 301 by the hook and fix between the hooked structure 3314 and the housing 301. The hooked structure 3314 may be referred to as a hooked portion 3314.

In general, the wearing member of the wearable electronic device may be detachably connected to the housing using a pin of a spring hinge bar provided in the link assembly. For example, the hinge bar is provided to be operated by pressing a lever or button disposed in the link assembly. In this case, the operation is not easy because the size of the lever or button is small. Further, it was difficult to operate the lever or button with one hand when the direction of pressing the lever or button is a direction crossing, on the same plane, the direction in which the wearing member is removed. In general, the strap of the mounting member may be fixedly coupled to the link assembly, so that replacement of the strap requires that a link assembly be purchased as well.

According to an embodiment of the disclosure, there may be provided a wearable electronic device in which the wearing member is easily detachable from the housing.

According to an embodiment of the disclosure, there may be provided a wearing member in which the strap may be easily separated from the cover assembly and a wearable electronic device including the same.

The disclosure is not limited to the foregoing embodiments but various modifications or changes may rather be made thereto without departing from the spirit and scope of the disclosure.

By the wearing member according to an embodiment of the disclosure and the wearable electronic device including the same, it is possible to easily change the design and/or material of the strap according to the purpose of use of the wearable electronic device and the user's preference.

Effects obtainable from the disclosure are not limited to the above-mentioned effects, and other effects not mentioned may be apparent to one of ordinary skill in the art from the following description.

According to an embodiment of the disclosure, a wearing member (e.g., the wearing member 302 of FIGS. 4A to 4C) of a wearable electronic device (e.g., the wearable electronic device 300 of FIGS. 4A to 4C) may include a strap (e.g., the strap 320 of FIGS. 4A to 4C), a cover assembly (e.g., the cover assembly 330 of FIGS. 4A to 4C), or a link assembly (e.g., the link assembly 340 of FIGS. 4A to 4C). The cover assembly may be coupled to one end of the strap. The link assembly may be configured to fix the cover assembly to a housing (e.g., the housing 301 of FIGS. 4A to 4C) of the wearable electronic device. The link assembly may include a main body (e.g., the main body 341 of FIGS. 5A to 5C), a first magnetic member (e.g., the first magnetic member 342 of FIGS. 5A to 5C), a button member (e.g., the button member 343 of FIGS. 5A to 5C), a second magnetic member (e.g., the second magnetic member 344 of FIGS. 5A to 5C), or a fixing member (e.g., the fixing member 345 of FIGS. 5A to 5C). The main body may include an internal space (e.g., the internal space 3413 of FIG. 6A). The first magnetic member may be disposed in the internal space. The button member may be configured to slide in a direction moving toward to the main body or a direction moving away from the main body. The button member may include a first recess (e.g., the first recess 3431a of FIG. 6A). The second magnetic member may be disposed in the first recess. The second magnetic member may face the first magnetic member. The fixing member may be disposed in the internal space. At least a portion of the fixing member may be configured to be detachably coupled to the housing of the wearable electronic device based on a slide of the button member.

According to an embodiment, the button member may be configured to slide in the direction moving away from the main body based on a repulsive force formed between the first magnetic member and the second magnetic member.

According to an embodiment, the button member may be configured to slide in the direction moving toward to the main body based on an external input.

According to an embodiment, the body may include a first main body portion (e.g., the first main body portion 3411 of FIG. 6A), a second main body portion (e.g., the second main body portion 3412 of FIG. 6A), or the internal space (e.g., the internal space 3413 of FIG. 6A). The second main body portion may cover at least a portion of the first main body portion and be coupled to the first main body portion. The internal space may be formed between the first main body portion and the second main body portion.

According to an embodiment, the second main body portion may include a first opening (e.g., the first opening 3412a of FIG. 6A). The first opening may receive it so that at least a portion of the button member is slidable.

According to an embodiment, a first internal space (e.g., the first internal space 3413a of FIG. 6A) or a second internal space (e.g., the second internal space 3413b of FIG. 6A) may be included. The first magnetic member may be disposed in the first internal space. The second internal space may be partitioned from the first internal space. In the second internal space, the fixing member may be disposed.

According to an embodiment, the button member may include a first main body portion (e.g., the first body portion 3431 of FIG. 6A), the first recess (e.g., the first recess 3431a of FIG. 6A), a first protruding portion (e.g., the first protruding portion 3432 of FIG. 6A), or a second protruding portion (e.g., the second protruding portion 3433 of FIG. 6A). An external input may be applied to the first main body portion. The first recess may be formed in a portion of the first main body portion facing the main body. The first protruding portion may protrude from the first body in a direction toward the main body. The second protruding portion may protrude from one end of the first protruding portion. The second protruding portion may include a second protruding portion 3433 inserted into at least a portion of the fixing member.

According to an embodiment, the fixing member may include a second main body portion (e.g., the second body portion 3451 of FIG. 6A), a connection portion (e.g., the second connection portion 3452 of FIG. 6A), or an inclined portion (e.g., the inclined portion 3453 of FIG. 6A). The second main body portion may be disposed to be slidable in at least one portion of the internal space. The connection portion may extend from the second main body portion. At least a portion of the connection portion may be disposed outside the main body. The inclined portion may be formed to be recessed in at least a portion of the second main body portion. At least a portion of the button member may be inserted into the inclined portion.

According to an embodiment, the connection portion may be configured to be fixed to the housing of the wearable electronic device or separated from the housing of the wearable electronic device based on a sliding movement of the second main body portion.

According to an embodiment, when the second main body portion is slid by the button member, the connection portion may be configured to be moved in the direction away from the first magnetic member to be fixed to the housing of the wearable electronic device or moved in the direction toward to the first magnetic member to be separated from the housing of the wearable electronic device.

According to an embodiment, the strap may include a first portion (e.g., the first portion 321 of FIG. 8B), a second portion (e.g., the second portion 322 of FIG. 8B), or an intermediate member (e.g., the intermediate member 323 of FIG. 8B). The first portion may form an inner surface of the strap. The second portion may form an outer surface of the strap. The intermediate member may be disposed between the first portion and the second portion.

According to one embodiment, the cover assembly may include a cover member (e.g., the cover member 331 of FIG. 8B) or a third magnetic member (e.g., the third magnetic member 332 of FIG. 8B). The cover member may be coupled to the strap. The cover member may be detachably coupled to the main body. The third magnetic member may be disposed at the cover member.

According to an embodiment, the cover member may include a third body portion (e.g., the third body portion 3311 of FIG. 8B) or a second recess (e.g., the second recess 3315 of FIG. 8B). The second recess may be formed in the third body portion. The third magnetic member may be disposed in the second recess.

According to an embodiment, the cover member may include a hooked structure (e.g., the hooked structure 3314 of FIG. 9B). The hooked structure may protrude from at least a portion of the third body portion. The hooked structure may configured to be hooked and fixed to at least a portion of the housing of the wearable electronic device.

According to an embodiment of the disclosure, the wearable electronic device (e.g., the wearable electronic device 300 of FIGS. 4A to 4C) may include a housing (e.g., the housing 301 of FIGS. 4A to 4C) or a wearing member (e.g., the wearing member 302 of FIGS. 4A to 4C). The seating area (e.g., the seating area 317 of FIGS. 4A to 4C) and a first connection portion (e.g., the first connection portion 311a of FIGS. 4A to 4C) may be formed in the housing. The wearing member may be detachably coupled to the seating area. The wearing member may include a strap (e.g., the strap 320 of FIGS. 4A to 4C), a cover assembly (e.g., the cover assembly 330 of FIGS. 4A to 4C), or a link assembly (e.g., the link assembly 340 of FIGS. 4A to 4C). The cover assembly may be coupled to one end of the strap. The link assembly may be configured to fix the cover assembly to a housing (e.g., the housing 301 of FIGS. 4A to 4C) of the wearable electronic device. The link assembly may include a main body (e.g., the main body 341 of FIGS. 5A to 5C), a first magnetic member (e.g., the first magnetic member 342 of FIGS. 5A to 5C), a button member (e.g., the button member 343 of FIGS. 5A to 5C), a second magnetic member (e.g., the second magnetic member 344 of FIGS. 5A to 5C), or a fixing member (e.g., the fixing member 345 of FIGS. 5A to 5C). The main body may include an internal space (e.g., the internal space 3413 of FIG. 6A). The first magnetic member may be disposed in the internal space. The button member may be configured to slide in a direction moving toward to the main body or a direction moving away from the main body. The button member may include a first recess (e.g., the first recess 3431a of FIG. 6A). The second magnetic member may be disposed in the first recess. The second magnetic member may face the first magnetic member. The fixing member may be disposed in the internal space. At least a portion of the fixing member may be detachably coupled to the first connection portion based on the sliding movement of the button member.

According to an embodiment, the button member may include a first main body portion (e.g., the first body portion 3431 of FIG. 6A), the first recess (e.g., the first recess 3431a of FIG. 6A), a first protruding portion (e.g., the first protruding portion 3432 of FIG. 6A), or a second protruding portion (e.g., the second protruding portion 3433 of FIG. 6A). An external input may be applied to the first main body portion. The first recess may be formed in a portion of the first main body portion facing the main body. The first protruding portion may protrude from the first body in a direction toward the main body. The second protruding portion may protrude from one end of the first protruding portion. The second protruding portion may include a second protruding portion 3433 inserted into at least a portion of the fixing member.

According to an embodiment, the fixing member may include a second main body portion (e.g., the second body portion 3451 of FIG. 6A), a second connection portion (e.g., the second connection portion 3452 of FIG. 6A), or an inclined portion (e.g., the inclined portion 3453 of FIG. 6A). The second main body portion may be disposed to be slidable in at least one portion of the internal space. The second connection portion may extend from the second main body portion. At least a portion of the second connection portion may be disposed outside the main body to be detachably coupled to the first connection portion. The inclined portion may be formed to be recessed in at least a portion of the second main body portion. At least a portion of the button member may be inserted into the inclined portion.

According to an embodiment, when the second main body portion is slid by the button member, the second connection portion may be moved in the direction away from the first magnetic member to be coupled to the first connection portion, or may be moved in the direction toward the first magnetic member to be separated from the first connection portion.

According to one embodiment, the cover assembly may include a cover member (e.g., the cover member 331 of FIG. 8B) or a third magnetic member (e.g., the third magnetic member 332 of FIG. 8B). The cover member may be coupled to the strap. The cover member may be detachably coupled to the main body. The third magnetic member may be disposed on the cover member. The third magnetic member may form an attractive force with the first magnetic member.

According to an embodiment, the cover member may include a hooked structure (e.g., the hooked structure 3314 of FIG. 9B). The hooked structure may protrude from at least a portion of the cover member. The hooked structure may be hooked and fixed to at least a portion of the housing of the wearable electronic device.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearing member of a wearable electronic device, the wearing member comprising:
a strap;
a cover assembly coupled to one end of the strap; and
a link assembly for fixing the cover assembly to a housing of the wearable electronic device, wherein the link assembly includes:
a main body including an internal space,
a first magnetic member disposed in the internal space,
a button member configured to slide in a first direction toward the main body or a second direction away from the main body, and including a first recess,
a second magnetic member disposed in the first recess and facing the first magnetic member, and
a fixing member disposed in the internal space, wherein at least a portion of the fixing member is configured to be detachably coupled to the housing of the wearable electronic device based on a sliding movement of the button member.

2. The wearing member of claim 1, wherein the button member is configured to slide in the second direction away from the main body based on a repulsive force formed between the first magnetic member and the second magnetic member.

3. The wearing member of claim 1, wherein the button member is configured to slide in the first direction toward the main body based on an external input.

4. The wearing member of claim 1,
wherein the main body includes:
a first main body portion, and
a second main body portion covering at least a portion of the first main body portion and coupled to the first main body portion, and
wherein the internal space is formed between the first main body portion and the second main body portion.

5. The wearing member of claim 4, wherein the second main body portion includes a first opening in which at least a portion of the button member is slidably received.

6. The wearing member of claim 1, wherein the internal space includes:
a first internal space where the first magnetic member is disposed, and
a second internal space partitioned from the first internal space, and where the fixing member is disposed.

7. The wearing member of claim 1,
wherein the button member includes:
a first body portion to which an external input is applied,
a first protruding portion protruding from the first body portion in a direction toward the main body, and
a second protruding portion protruding from an end of the first protruding portion and inserted in at least a part of the fixing member, and
wherein the first recess is formed in a portion, facing the main body, of the first body portion.

8. The wearing member of claim 1, wherein the fixing member includes:
a second body portion slidably disposed in at least a portion of the internal space,
a connection portion extending from the second body portion, wherein at least a portion of the connection portion is disposed outside of the main body, and
an inclined portion formed to be recessed in at least a portion of the second body portion and where at least a portion of the button member is inserted.

9. The wearing member of claim 8, wherein the connection portion is configured to be fixed to the housing of the wearable electronic device or separated from the housing of the wearable electronic device based on a sliding movement of the second body portion.

10. The wearing member of claim 8, wherein when the second body portion is slid by the button member, the connection portion is configured to be moved in a third direction away from the first magnetic member to be fixed to the housing of the wearable electronic device or moved in a fourth direction toward the first magnetic member to be separated from the housing of the wearable electronic device.

11. The wearing member of claim 1, wherein the strap includes:
a first portion forming an inner surface of the strap,
a second portion forming an outer surface of the strap, and
an intermediate member disposed between the first portion and the second portion.

12. The wearing member of claim 1, wherein the cover assembly includes:
a cover member coupled to the strap and detachably coupled to the main body, and
a third magnetic member disposed at the cover member.

13. The wearing member of claim 12, wherein the cover member includes:
a third body portion, and
a second recess formed in the third body portion and where the third magnetic member is disposed.

14. The wearing member of claim 13, wherein the cover member includes a hooked structure protruding from at least a portion of the third body portion, and configured to be hooked and fixed to at least a portion of the housing of the wearable electronic device.

15. A wearable electronic device, comprising:
a housing, in which a seating area and a first connection portion are formed; and
a wearing member detachably coupled to the seating area,
wherein the wearing member includes:
a strap,
a cover assembly coupled to one end of the strap, and
a link assembly for fixing the cover assembly to the seating area, and
wherein the link assembly includes:
a main body including an internal space,
a first magnetic member disposed in the internal space,
a button member configured to slide in a first direction toward the main body or a second direction away from the main body, and including a first recess,
a second magnetic member disposed in the first recess and facing the first magnetic member, and
a fixing member disposed in the internal space, wherein at least a portion of the fixing member is detachably coupled to the first connection portion based on a sliding movement of the button member.

16. The wearable electronic device of claim 15,
wherein the button member includes:
a first body portion to which an external input is applied,
a first protruding portion protruding from the first body portion in a direction toward the main body, and
a second protruding portion protruding from an end of the first protruding portion and inserted in at least a part of the fixing member, and
wherein the first recess is formed in a portion, facing the main body, of the first body portion.

17. The wearable electronic device of claim 15, wherein the fixing member includes:
a second body portion slidably disposed in at least a portion of the internal space,
a second connection portion extending from the second body portion, wherein at least a portion of the second connection portion is disposed outside of the main body, and
an inclined portion formed to be recessed in at least a portion of the second body portion and where at least a portion of the button member is inserted.

18. The wearable electronic device of claim 17, wherein when the second body portion is slid by the button member, the second connection portion is configured to be moved in a third direction away from the first magnetic member to be fixed to the housing of the wearable electronic device or moved in a fourth direction toward the first magnetic member to be separated from the housing of the wearable electronic device.

19. The wearable electronic device of claim 15,
wherein the cover assembly includes:
a cover member coupled to the strap and detachably coupled to the main body, and
a third magnetic member disposed at the cover member, and
wherein the cover member includes:
a third body portion, and
a second recess formed in the third body portion and where the third magnetic member is disposed.

20. The wearable electronic device of claim 19, wherein the cover member includes a hooked structure protruding from at least a portion of the third body portion, and configured to be hooked and fixed to at least a portion of the housing of the wearable electronic device.
